(19) United States
(12) Patent Application Publication
(10) Pub. No.: US 2026/0211914 A1
(43) Pub. Date: Jul. 23, 2026

(54) DATA-DRIVEN CONTENT INTERACTION

(71) Applicants: DISNEY ENTERPRISES, INC., Burbank, CA (US); HULU, LLC, Santa Monica, CA (US)

(72) Inventors: Yang YU, Los Angeles, CA (US); Yan ZHANG, Bellevue, WA (US); Zhe WANG, Foster City, CA (US); Zhaohui YE, Los Angeles, CA (US); Pengfei GAO, Los Angeles, CA (US)

(21) Appl. No.: 19/035,731

(22) Filed: Jan. 23, 2025

(51) Int. Cl. G06F 16/3329; G06F 16/901; G06F 40/30

(52) U.S. Cl. CPC G06F 16/33295; G06F 16/9024; G06F 40/30

(57) ABSTRACT

One embodiment of the present invention sets forth a technique for processing user input. The technique includes determining, via execution of a first machine learning model, a first intent associated with a first message that is received from a user during an interaction associated with a first content item. The technique also includes matching the first intent to a first portion of a graph associated with the interaction. The technique further includes determining, based on the first portion of the graph, a first response to the first message, and causing a second content item corresponding to the first response to be outputted to the user.

### BACKGROUND

### Field of the Various Embodiments

Embodiments of the present disclosure relate generally to machine learning and content generation and, more specifically, to data-driven content interaction.

### Description of the Related Art

Advances in computer and network technology have led to an increase in the availability and use of digital content in various contexts and environments. For example, users may access content in the form of images, video, audio, text, graphics, animations, multimedia, and/or other types of digital from personal computers, laptop computers, workstations, mobile phones, tablet computers, game consoles, eBook readers, televisions, projectors, speakers, virtual reality (VR) devices, augmented reality (AR) devices, mixed reality (MR) devices, extended reality (XR) devices, wearable devices, music players, and/or other types of electronic devices. The digital content may be delivered via one or more files, streams of network packets, and/or digital broadcasts.

However, user experiences with digital content tend to be one-directional and static. More specifically, digital content is typically stored in a pre-recorded and/or pre-generated form and subsequently delivered to a user on demand, based on a schedule, and/or based on other factors. While the user can consume the delivered content in various forms via various output devices (e.g., display, speaker, haptic device, etc.), the user is limited in the ability to interact with the delivered content. For example, the user may be able to provide limited feedback (e.g., a thumbs up or down, rating, etc.) on the delivered content but cannot otherwise drive the direction of the content being delivered.

Further, conventional techniques for enabling interaction between users and digital content may disrupt engagement with a given piece of content. For example, a video that is streamed on an electronic device may be accompanied by a Uniform Resource Locator (URL), QR code, and/or other metadata that links to a webpage and/or another source of additional information related to the video. When a user of the electronic device uses the metadata to access the additional information (e.g., by clicking a link, scanning the QR code, etc.), the user may navigate away from a platform used to stream the video, thereby interrupting the consumption of the video by the user and potentially negatively impacting the user experience with the video.

As the foregoing illustrates, what is needed in the art are more effective techniques for improving interaction between users and digital content.

### SUMMARY

One embodiment of the present invention sets forth a technique for processing user input. The technique includes determining, via execution of a first machine learning model, a first intent associated with a first message that is received from a user during an interaction associated with a first content item. The technique also includes matching the first intent to a first portion of a graph associated with the interaction. The technique further includes determining, based on the first portion of the graph, a first response to the first message, and causing a second content item corresponding to the first response to be outputted to the user.

One technical advantage of the disclosed techniques relative to the prior art is an increase in the range of interactions that can be conducted between users and content items. More specifically, various paths composed of nodes and edges in the graph may be used to track messages from the user and deliver corresponding responses that account for previous interactions between the user and the content item. Consequently, interactions that are conducted using the disclosed techniques may be more dynamic, nuanced, and relevant than conventional approaches that are limited in the ability to receive and/or process user inputs related to content items. Another technical advantage of the disclosed techniques is the ability to generate and deliver responses to messages from the user that are safe, relevant to the content item, aligned with the intended use of the content item, stylistically similar to the content item, delivered in an efficient and/or timely manner, and/or otherwise appropriate for use in an interaction with the content item. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a computing device configured to implement one or more aspects of various embodiments.

FIG. 2 is a more detailed illustration of the generation engine and interaction engine of FIG. 1, according to various embodiments.

FIG. 3 illustrates an example graph representing interactions associated with a content item, according to various embodiments.

FIG. 4 illustrates how the generation engine of FIG. 1 a response to a given canonical question, according to various embodiments.

FIG. 5 is a flow diagram of method steps for conducting an interaction with a user, according to various embodiments.

FIG. 6 is a flow diagram of method steps for conducting an interaction with a user, according to various embodiments.

### DETAILED DESCRIPTION

In the following description, numerous specific details are set forth to provide a more thorough understanding of the various embodiments. However, it will be apparent to one of skill in the art that the inventive concepts may be practiced without one or more of these specific details.

### System Overview

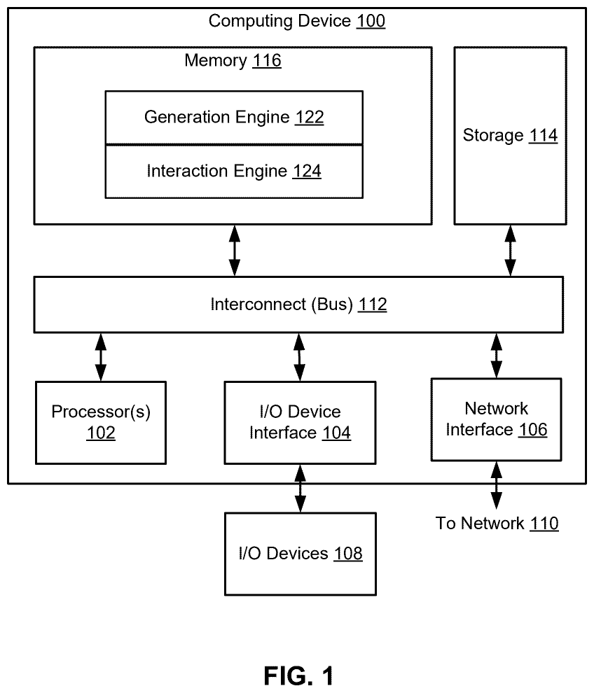

FIG. 1 illustrates a computing device 100 configured to implement one or more aspects of various embodiments. In one embodiment, computing device 100 includes a desktop computer, a laptop computer, a smart phone, a personal digital assistant (PDA), tablet computer, or any other type of computing device configured to receive input, process data, and optionally display images, and is suitable for practicing one or more embodiments. Computing device 100 is configured to run a generation engine 122 and an interaction engine 124 that reside in memory 116.

It is noted that the computing device described herein is illustrative and that any other technically feasible configurations fall within the scope of the present disclosure. For example, multiple instances of generation engine 122 and interaction engine 124 could execute on a set of nodes in a distributed and/or cloud computing system to implement the functionality of computing device 100. In another example, generation engine 122 and/or interaction engine 124 could execute on various sets of hardware, types of devices, or environments to adapt generation engine 122 and/or interaction engine 124 to different use cases or applications. In a third example, generation engine 122 and interaction engine 124 could execute on different computing devices and/or different sets of computing devices.

In one embodiment, computing device 100 includes, without limitation, an interconnect (bus) 112 that connects one or more processors 102, an input/output (I/O) device interface 104 coupled to one or more input/output (I/O) devices 108, memory 116, a storage 114, and a network interface 106. Processor(s) 102 may be any suitable processor implemented as a central processing unit (CPU), a graphics processing unit (GPU), an application-specific integrated circuit (ASIC), a field programmable gate array (FPGA), an artificial intelligence (AI) accelerator, any other type of processing unit, or a combination of different processing units, such as a CPU configured to operate in conjunction with a GPU. In general, processor(s) 102 may be any technically feasible hardware unit capable of processing data and/or executing software applications. Further, in the context of this disclosure, the computing elements shown in computing device 100 may correspond to a physical computing system (e.g., a system in a data center) or may be a virtual computing instance executing within a computing cloud.

I/O devices 108 include devices capable of providing input, such as a keyboard, a mouse, a touch-sensitive screen, a microphone, and so forth, as well as devices capable of providing output, such as a display device or a speaker. Additionally, I/O devices 108 may include devices capable of both receiving input and providing output, such as a touchscreen, a universal serial bus (USB) port, and so forth. I/O devices 108 may be configured to receive various types of input from an end-user (e.g., a designer) of computing device 100, and to also provide various types of output to the end-user of computing device 100, such as displayed digital images or digital videos or text. In some embodiments, one or more of I/O devices 108 are configured to couple computing device 100 to a network 110.

Network 110 is any technically feasible type of communications network that allows data to be exchanged between computing device 100 and external entities or devices, such as a web server or another networked computing device. For example, network 110 may include a wide area network (WAN), a local area network (LAN), a wireless (WiFi) network, and/or the Internet, among others.

Storage 114 includes non-volatile storage for applications and data, and may include fixed or removable disk drives, flash memory devices, and CD-ROM, DVD-ROM, Blu-Ray, HD-DVD, or other magnetic, optical, or solid-state storage devices. Generation engine 122 and interaction engine 124 may be stored in storage 114 and loaded into memory 116 when executed.

Memory 116 includes a random-access memory (RAM) module, a flash memory unit, or any other type of memory unit or combination thereof. Processor(s) 102, I/O device interface 104, and network interface 106 are configured to read data from and write data to memory 116. Memory 116 includes various software programs that can be executed by processor(s) 102 and application data associated with said software programs, including generation engine 122 and interaction engine 124.

In one or more embodiments, generation engine 122 and interaction engine 124 include functionality to perform data-driven interaction between a content item and a user. During this data-driven interaction, content associated with the content item is selected, modified, and/or outputted based on questions and/or other types of interactive input from the user. For example, the content item may include a movie, television show, informational video, instructional video, and/or another type of video that is outputted to the user. After the user has viewed some or all of the video, the user may ask questions, provide comments, and/or generate other types of user input related to characters, locations, objects, topics, concepts, data points, guidelines, suggestions, and/or other attributes associated with content presented in the video. Each user input is matched to a corresponding response, and the response is outputted to the user as text, another video, and/or another type of content. Generation engine 122 and interaction engine 124 are described in further detail below.

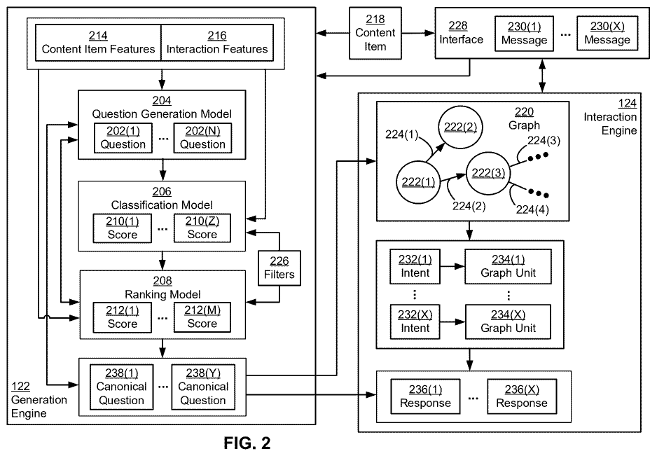

FIG. 2 is a more detailed illustration of generation engine 122 and interaction engine 124 of FIG. 1. As mentioned above, generation engine 122 and interaction engine 124 are configured to perform data-driven interaction associated with a content item 218. Each of these components is described in further detail below.

Content item 218 provides information to users via one or more types of content. For example, content item 218 may include (but is not limited to) a movie, television show, song, trailer, preview, multimedia presentation, article, white paper, blog post, book, testimonial, infographic, instruction manual, guide, press release, interview, newsletter, document, template, photo, graphic, illustration, animation, webinar, lesson, podcast, social media post, and/or another type of content. Content within content item 218 may include (but is not limited to) facts, findings, hypotheses, theories, arguments, suggestions, guidelines, rules, demonstrations, tutorials, recommendations, promotions, opportunities, case studies, experimental results, policies, opinions, and/or other types of information.

In some embodiments, interaction between one or more users and content item 218 is performed using a graph a graph 220 representing potential interactions between the user(s) and content item 218. As shown in FIG. 2, graph 220 includes nodes 222(1)-222(3) (each of which is referred to individually herein as node 222) and edges 224(1)-224(3) (each of which is referred to individually herein as edge 224) that represent potential messages 230(1)-230(X) (each of which is referred to individually herein as message 230) from the user(s) and responses 236(1)-236(X) (each of which is referred to individually herein as response 236) to those messages 230.

For example, graph 220 may include a root node 222 that represents consumption of content item 218 by a user. Directed edges 224 from the root node 222 to a first level of child nodes 222 may represent potential messages 230 that can be received from the user before, during, and/or after consumption of the content item by the user. A first-level child node 222 that is connected to one of these directed edges 224 may represent a certain response 236 to the corresponding message 230. Additional outgoing edges 224 from each first-level child node 222 to one or more second-level child nodes 222 may represent potential follow-up messages 230 from the user after the corresponding response 236 has been outputted to the user. Each of these additional edges 224 may terminate in a second-level child node 222 that represents a certain response 236 to the corresponding follow-up message 230. Additional levels edges 224 and nodes 222 may be included in graph 220 to represent additional rounds of interaction between the user and content item 218.

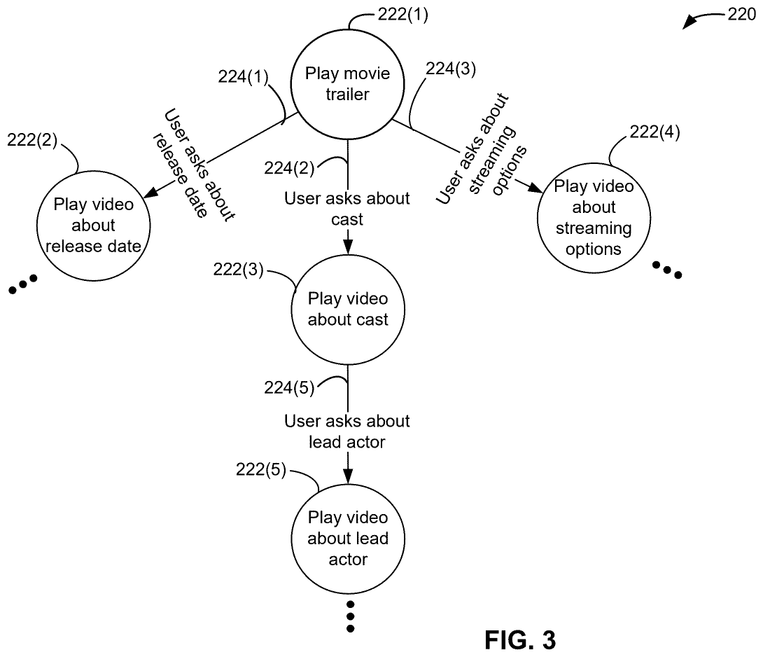

FIG. 3 illustrates an example graph 220 representing interactions associated with content item 218, according to various embodiments. As shown in FIG. 3, graph 220 includes a root node 222(1) that represents an action of playing a movie trailer corresponding to content item 218 to a user. The root node 222(1) is associated with three outgoing edges 224(1), 224(2), and 224(3) that lead to three first-level child nodes 222(2), 222(3), and 222(4).

Edge 224(1) represents a first question from the user about the release date of the movie. The child node 222(2) into which edge 224(1) terminates indicates that a response to the first question includes playing a video about the release date of the movie.

Edge 224(2) represents a second question from the user about the cast of the movie. The child node 222(3) into which edge 224(2) terminates indicates that a response to the second question includes playing a video about the cast of the movie.

Edge 224(3) represents a third question from the user about streaming options for the movie. The child node 222(4) into which edge 224(3) terminates indicates that a response to the third question includes playing a video about streaming options for the movie.

Child node 222(3) includes an outgoing edge 224(5) that represents a fourth question from the user about the lead actor in the movie. Edge 224(5) is also connected to a second-level child node 222(5) that indicates that a response to the fourth question includes playing a video about the lead actor in the movie.

Further, the path that includes the root node 222(1), edge 224(2), node 222(3), edge 224(5), and node 222(5) indicates that the video about the lead actor should be played after the user has viewed the movie trailer, asked about the cast of the movie, viewed the video about the cast of the movie, and asked about the lead actor of the movie. In other words, the content of the video about the lead actor represented by node 222(5) should reflect the content of the movie trailer, the previously asked question about the cast, and the corresponding video response.

Alternatively, if the content of the video about the lead actor does not vary based on previous interactions with the user about the movie trailer, graph 220 may include additional edges 224 that represent the question about the lead actor and connect other nodes 222(1), 222(2), and/or 224(4) to node 222(5). Consequently, graph 220 may be structured in a way that reflects the customization of responses to certain questions based on previous questions and responses and/or the use of the same response for different sequences of questions that include the same question.

Returning to the discussion of FIG. 2, generation engine 122 uses a number of machine learning models to generate graph 220. Input into each machine learning models may include content item features 214 related to content item 218. For example, content item features 214 may include a title, description, synopsis, genre, industry, writer, creator, director, producer, composer, cinematographer, studio, cast, format, and/or other metadata related to content item 218. Content item features 214 may also, or instead, include text, images, audio, video, and/or other types of content included in content item 218; scripts, storyboards, notes, commentary, and/or other data related to the creation of content item 218; characters, settings, locations, objects, themes, topics, sentiments, conclusions, and/or other information related to the content in content item 218; and/or other semantic information related to content item 218. Content item features 214 may also, or instead, include bounding boxes, semantic segmentations, class labels, and/or other machine learning outputs associated with content item 218. Content item features 214 may also, or instead, include pixel values, histograms, color curves, edges, contours, corners, points, textures, frequency decompositions, beats, rhythms, harmonies, melodies, spectrograms, statistics, and/or other information related to image data, audio data, video data, text, and/or other data included in content item 218. Content item features 214 may also, or instead, include information that can be used to guide interactions with content item 218, such as (but not limited to) an intended use associated with content item 218 (e.g., instructional content, promotional content, informational content, persuasive content, etc.), one or more metrics to be optimized via the interactions (e.g., clicks, site visits, conversions, etc.), and/or one or more “goals” associated with the interactions (e.g., user engagement, learning, troubleshooting, etc.). When content item 218 is outputted in the context of other content (e.g., as material and/or supplemental content that is delivered during breaks in the other content), content item features 214 may include information related to the other content.

Input into the machine learning models also, or instead, includes interaction features 216 related to historical interactions between users and content item 218 and/or other content items. For example, interaction features 216 may include historical messages received from users during interaction with a given content item, responses to the historical messages, and/or outcomes related to the messages and/or responses (e.g., user-provided ratings, levels of user engagement, clicks, conversions, churn, etc.). Content items associated with these interaction features 216 may include content item 218 and/or one or more content items that are similar to content item 218 (e.g., content items associated with the same creator, themes, topics, genres, intended use, metrics, objectives, etc.).

As shown in FIG. 2, the machine learning models include a question generation model 204, a classification model 206, and a ranking model 208. Each machine learning model may be implemented using a large language model (LLM), vision language model (VLM), multimodal language model (MMLM), and/or another type of machine learning model that is capable of general-purpose language understanding and generation. Each machine learning model may also, or instead, use tokenization, part-of-speech tagging, named entity recognition, topic modeling, sentiment analysis, object detection, semantic segmentation, object and/or gesture tracking, facial expression detection, pose estimation, embedding, and/or other machine learning and/or natural language processing (NLP) techniques to understand the structure and/or meaning of content item features 214 and/or interaction features 216. Each machine learning model may also, or instead, include a regression model, tree-based model, support vector machine, artificial neural network, Bayesian network, and/or another type of machine learning architecture.

Generation engine 122 uses question generation model 204 to generate potential questions 202(1)-202(N) (each of which is referred to individually herein as question 202) that can be asked by users during potential interactions with content item 218. For example, generation engine 122 may input, into question generation model 204, content item features 214, interaction features 216, and/or a prompt to generate questions 202 based on content item features 214 and interaction features 216. Generation engine 122 may also, or instead, provide example questions associated with other content items, types of questions 202 that can be generated, the structure and/or format associated with a given question 202, guidelines and/or rules for generating questions 202, and/or other information that can assist question generation model 204 in the task of generating questions 202 related to content item 218.

After a given set of questions 202 is outputted by question generation model 204, generation engine 122 uses classification model 206 to compute a corresponding set of scores 210(1)-210(Z) (each of which is referred to individually herein as score 210). Each score 210 may represent the degree to which a corresponding question 202 is relevant to content item 218, valid, appropriate, safe, and/or otherwise deemed to be a good fit for interactions with content item 218. For example, classification model 206 may include a transformer neural network, LLM, and/or another type of machine learning model that converts tokens and/or embeddings representing a given question 202 into one or more scores 210, where each score 210 ranges between 0 and 1 and represents the extent to which a corresponding attribute (e.g., relevance, quality, appropriateness, safety, etc.) is met by that question 202.

Generation engine 122 applies one or more filters 226 to questions 202 based on scores 210 and/or other criteria. For example, filters 226 may include a minimum threshold for individual scores 210 associated with each question 202 and/or an aggregate score 210 that is computed from multiple scores 210 (e.g., as a sum, average, weighted average, etc.) for the same question 202. Filters 226 may also, or instead, include user feedback related to questions 202, such as (but not limited to) human-generated input that identifies a given question 202 as a good or bad fit for content item 218 and/or a human-generated score to which a corresponding threshold is applied. This user feedback may be used to retrain classification model 206, so that subsequent scores 210 outputted by classification model 206 better reflect preferences, requirements, and/or priorities associated with the relevance of questions 202 to content item 218 and/or other content items.

Generation engine 122 uses ranking model 208 to generate additional scores 212(1)-212(M) (each of which is referred to individually herein as score 212) for a subset of questions 202 that pass filters 226 associated with scores 210. Like classification model 206, ranking model 208 may include a transformer neural network, LLM, and/or another type of machine learning model that converts tokens and/or embeddings representing a given question 202 into one or more scores 212. However, unlike scores 210 generated by classification model 206, scores 212 generated by ranking model 208 may represent predictions related to the intended use of content item 218. For example, each score 212 associated with a given question 202 may represent a prediction of the likelihood of that question 202 being asked; a change in user engagement with content item 218, click-through rate, conversion rate, and/or another metric as a result of a user asking that question 202; and/or a relevance of that question 202 to a goal, objective, and/or intended use associated with content item 218.

In some embodiments, generation engine 122 applies additional filters 226 to questions 202 based on scores 212. For example, filters 226 may include a minimum threshold for individual scores 212 associated with each question 202 and/or an aggregate score 212 that is computed from multiple scores 212 (e.g., as a sum, average, weighted average, etc.) for the same question 202. Filters 226 may also, or instead, include user feedback related to questions 202, such as (but not limited to) human-generated input that identifies a given question 202 as a good or bad fit for an intended use of content item 218 and/or a human-generated score to which a corresponding threshold is applied. This user feedback may be used to retrain ranking model 208, so that subsequent scores 212 outputted by ranking model 208 better reflect preferences, requirements, and/or priorities associated with the relevance of questions 202 to goals, objectives, and/or use of content item 218 and/or other content items.

Generation engine 122 uses a subset of questions 202 that pass filters 226 associated with scores 212 and/or human-generated input to generate a set of canonical questions 238(1)-238(Y) (each of which is referred to individually herein as canonical question 238) associated with content item 218. Each canonical question 238 represents a “standardized” semantic meaning and/or intent associated with a corresponding question 202. For example, generation engine 122 may use a machine learning model, a user, and/or another technique to convert a filtered question 202 of “How long can this phone run on battery?” into a corresponding canonical question 238 of “user asks about battery life on phone.”

Generation engine 122 populates graph 220 with representations of canonical questions 238. For example, generation engine 122 may create a root node 222 that represents content item 218. Generation engine 122 may also create a set of outgoing edges 224 from the root node 222. Each outgoing edge 224 from the root node 222 may represent a different canonical question 238 and include an identifier for that canonical question 238, the text of that canonical question 238, an embedding of that canonical question 238, and/or another representation of that canonical question 238. Each edge 224 originating from the root node 222 may also be connected to a child node 222 of the root node 222. This child node 222 may represent a corresponding response 236 to that canonical question 238.

In some embodiments, generation engine 122 inputs a given canonical question 238 that has been added to graph 220 into question generation model 204, so that question generation model 204 outputs one or more additional questions 202 as potential follow-up questions related to the inputted canonical question 238. For example, generation engine 122 may add a given canonical question 238 to a prompt for question generation model 204, content item features 214 associated with content item 218, and/or other types of input into question generation model 204. Generation engine 122 may also, or instead, modify the prompt to instruct question generation model 204 to generate follow-up questions 202 to the inputted canonical question 238. Given this input, question generation model 204 may output one or more questions 202 that account for the intent associated with the inputted canonical question 238.

Generation engine 122 uses classification model 206, ranking model 208, and filters 226 to process each set of questions 202 generated by question generation model 204 from a given inputted canonical question 238, thereby resulting in an additional set of canonical questions 238 that function as follow-up questions associated with the inputted canonical question 238. Generation engine 122 then adds representations of these additional canonical questions 238 and corresponding responses 236 to graph 220 (e.g., as outgoing edges 224 from a given node 222 representing the inputted canonical question 238 and additional child nodes 222 connected to these edges 224). Generation engine 122 may also repeat the process with each follow-up question to generate additional levels of child nodes 222 in graph 220, thereby extending the length of potential interactions between users and content item 218.

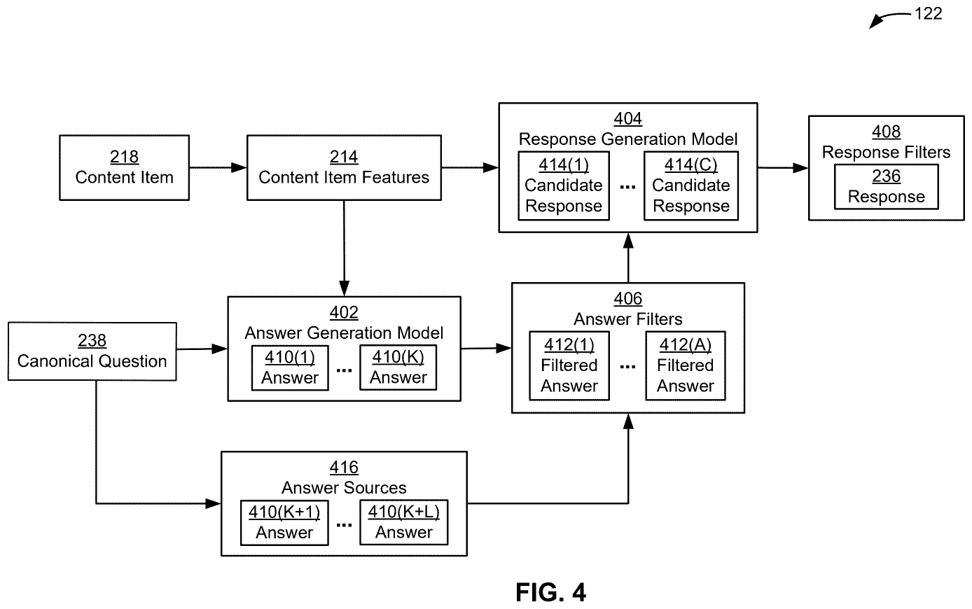

In one or more embodiments, generation engine 122 uses one or more additional machine learning models (not shown in FIG. 2) to generate responses 236 to canonical questions 238. Each response 236 may be generated in a way that replicates and/or mimics the style, appearance, setting, “feel,” and/or other attributes of content item 218. For example, responses 236 to canonical questions 238 associated with a video-based content item 218 may include videos that include the same actors, characters, background, voices, animation styles, and/or other attributes of content item 218. Because these responses 236 are stylistically aligned with content item 218, users may interpret these responses 236 as interactive extensions of content item 218 instead of additional content that interrupts and/or negatively impacts the consumption of content item 218. The generation of responses 236 to canonical questions 238 in a way that is “in context” with content item 218 is described in further detail below with respect to FIG. 4.

FIG. 4 illustrates how generation engine 122 of FIG. 1 generates response 236 to a given canonical question 238, according to various embodiments. As shown in FIG. 4, generation engine 122 uses an answer generation model 402 and/or one or more answer sources 416 to generate a set of answers 410(1)-410(K) and answers 410(K+1)-410(K+L) (each of which is referred to individually herein as answer 410) to canonical question 238.

In some embodiments, answer generation model 402 includes an LLM, VLM, MMLM and/or another type of machine learning model that is capable of understanding canonical question 238. In addition to canonical question 238, input into answer generation model 402 may include content item features 214 that can be used to generate an answer to canonical question 238. For example, canonical question 238 may include a request for more information related to the battery life on a wearable device that is the subject of content item 218. Content item features 214 related to content item may include features and/or specifications associated with the wearable device, which can be analyzed by answer generation model 402 to locate battery information related to the wearable device. Input into answer generation model 402 may also, or instead, include a prompt to generate one or more answers 410 to canonical question 238 based on content item features 214. The prompt may include additional instructions related to the tone, format, style, length, and/or other attributes of each generated answer 410; example answers to other canonical questions for the same content item 218 and/or different content items; and/or other information that can be used by answer generation model 402 to generate answers 410. Based on this input, answer generation model 402 may generate a set of answers 410 to question in a way that adheres to the specified attributes.

In one or more embodiments, answer sources 416 include external sources of answers 410 to canonical question 238. For example, answer sources 416 may include users that are tasked with generating answers 410 to canonical question 238 based on content item features 214 and/or other information related to content item 218.

Generation engine 122 applies a set of answer filters 406 to answers 410 from answer generation model 402 and/or answer sources 416, resulting in a corresponding set of filtered answers 412(1)-412(A) (each of which is referred to individually herein as filtered answer 412). This set of filtered answers 412 may correspond to a subset of answers 410 that meet answer filters 406. For example, answer filters 406 may include thresholds, criteria, user input, and/or other representations of relevance, appropriateness, safety, correctness, and/or other requirements associated with answers 410. Answer filters 406 may be implemented using machine learning models that generate scores associated with the requirements, humans that rate and/or classify answers 410 based on the requirements, and/or other mechanisms.

Generation engine 122 uses a response generation model 404 to generate, for each filtered answer 412, one or more candidate responses 414(1)-414(C) (each of which is referred to individually herein as candidate response 414). For example, response generation model 404 may include a transformer neural network and/or another type of machine learning model that is capable of outputting images, text, audio, video, and/or other types of content that are similar to and/or match those in content item 218. In addition to a given filtered answer 412, input into response generation model 404 may include content item features 214 such as (but not limited to) backgrounds, characters, faces, objects, scenes, settings, voices, sounds, music, and/or other elements of content item 218. Given this input, response generation model 404 generates each candidate response 414 as video, audio, text, images, and/or other types of content that match those of content item 218.

Each candidate response 414 may include elements of content item 218, as specified in the inputted content item features 214. Each candidate response 414 may also include a representation of the inputted filtered answer 412. For example, a given candidate response 414 for a video-based content item 218 may include a video of a scene that includes one or more characters from content item 218. Within the scene, the character(s) may speak lines that correspond to text in the inputted filtered answer 412. Consequently, each candidate response 414 may include elements that convey the sense that that candidate response 414 is an extension of content item 218 instead of a different piece of content that disrupts the user experience with content item 218.

Generation engine 122 uses a set of response filters 408 to select, from a set of candidate responses 414 generated by response generation model 404 from one or more filtered answers 412 to canonical question 238, a final response 236 to canonical question 238. For example, response filters 408 may include thresholds, criteria, user input, and/or other representations of relevance, appropriateness, safety, correctness, stylistic similarity to content item 218, temporal and/or spatial coherence, and/or other requirements and/or priorities associated with candidate responses 414. Response filters 408 may be implemented using machine learning models that generate scores associated with the requirements, humans that rate and/or classify candidate responses 414 based on the requirements, and/or other mechanisms. The selected response 236 may thus correspond to a given candidate response 414 that best meets these requirements and/or priorities.

Returning to the discussion of FIG. 2, once a certain response 236 is generated and/or selected for a corresponding canonical question 238, generation engine 122 adds a representation of that response 236 to graph 220. For example, generation engine 122 update graph 220 with a new node 222 representing that response 236. This node 222 may include an identifier, location, and/or other information that can be used to retrieve response 236. This node 222 may also be connected to an incoming edge 224 that represents the corresponding canonical question 238.

After generation engine 122 generates graph 220 and responses 236 for a given content item 218, interaction engine 124 uses graph 220 and responses 236 to conduct an interaction related to content item 218 with a user. As shown in FIG. 2, the interaction may involve outputting content item 218 to the user via interface 228. For example, interaction engine 124 and/or another component may use one or more output devices that are associated with interface 228 and/or independent of interface 228 to output audio, images, video, tactile content, text, multimedia, and/or other types of content included in content item 218.

Before content item 218 is outputted to the user, during output of content item 218 to the user, and/or after content item 218 is outputted to the user, the user may submit messages 230 related to content item 218 over interface 228. For example, the user may generate messages 230 in the form of voice input, text, gestures, facial expressions, mouse input, joystick input, and/or other types of user input. The input may be received over interface 228 on a personal computer, laptop computer, workstation, mobile phone, tablet computer, game console, AR device, MR device, XR device, VR device, wearable device, and/or another type of electronic device.

Interaction engine 124 receives each message 230 from interface 228 and/or a computing device on which interface 228 is provided. Interaction engine 124 also determines an intent 232(1)-232(X) (each of which is referred to individually herein as intent 232) associated with each message 230. For example, interaction engine 124 and/or the computing device from which message 230 was received may use one or more machine learning models to convert that message 230 into standardized text, one or more embeddings, one or more class predictions, and/or another semantic representation corresponding to intent 232.

Interaction engine 124 matches each intent 232 to a corresponding graph unit 234(1)-234(X) (each of which is referred to individually herein as graph unit 234) included in graph 220. Each graph unit 234 may include a discrete portion of graph 220. For example, graph units 234 may correspond to edges 224 in graph 220 that represent canonical questions 238. Each graph unit 234 may include and/or be associated with an embedding, text, class label, and/or other semantic representation of a corresponding canonical question 238.

In some embodiments, a matching graph unit 234 for a given intent 232 includes a semantic representation that is closest to the semantic representation of that intent 232. For example, interaction engine 124 may compute vector distances between an embedding of that intent 232 and embeddings of canonical questions 238 represented by outgoing edges 224 from a given node 222 associated with a previously outputted response 236. Interaction engine 124 may then select the matching graph unit 234 as an outgoing edge 224 associated with the smallest vector distance to the embedding of that intent 232.

Interaction engine 124 also uses a given graph unit 234 to generate and/or retrieve a certain response 236 that can be used to answer a question represented by the corresponding intent 232. Continuing with the above example, interaction engine 124 may follow the outgoing edge 224 that matches that intent 232 to a certain node 222 representing response 236. Interaction engine 124 may use an identifier, location, and/or other information included in and/or associated with that node 222 to retrieve a pre-generated response 236 (e.g., from a data store).

Interaction engine 124 also causes that response 236 to be outputted to the user over interface 228. For example, interaction engine 124 may transmit audio, video, image, and/or other data included in response 236 to the computing device providing interface 228. The computing device may use the transmitted data to generate output that allows the user to consume the transmitted response 236 as an answer to a question represented by the previously received message 230.

After the transmitted response 236 has been outputted via interface 228 to the user, the user may generate one or more additional messages 230 related to content item 218 and/or the outputted response 236. For example, the user may include, in the subsequent message 230, a follow-up question that is related to the information in content item 218, a question included in the previous message 230, and/or the outputted response 236. For each new message 230 received from the user, interaction engine 124 may determine a corresponding intent 232, match that intent 232 to a given graph unit 234 in graph 220, use that graph unit 234 to retrieve a pre-generated response 236, and transmit and/or output that response 236 to the user via interface 228.

In one or more embodiments, interaction engine 124 performs a traversal of graph 220 as messages 230 related to content item 218 are sequentially received from a given user. More specifically, interaction engine 124 may receive a first message 230 from the user and/or convert the first message 230 into a corresponding intent 232 before, during, or after consumption of content item 218 by the user. Interaction engine 124 may attempt to match that intent 232 to a corresponding graph unit 234 included in a topmost level of outgoing edges 224 from a root node 222 that represents content item 218. For example, interaction engine 124 may use a machine learning model associated with the topmost level of outgoing edges 224 from the root node 222 to generate the corresponding intent 232 as a predicted class label for the first message 230. Output of the machine learning model may include predicted scores for D+1 classes, where D classes represent D intents 232 associated with the outgoing edges 224 from the root node 222 and the additional class corresponds to an “other” intent that is not represented by an edge in graph 220. When the highest score outputted by the machine learning model is associated with a given intent 232 that is represented by an outgoing edge 224 from the root node 222, interaction engine 124 may return a corresponding response 236 for output over interface 228. When the highest score corresponds to the “other” intent, interaction engine 124 may return a “default” response 236 associated with the “other” intent (e.g., a response that prompts the user to ask a different question, a response that ends the interaction, etc.).

After the user has consumed the returned response 236 to the first message 230, interaction engine 124 may receive a second message 230 from the user and/or determine a new intent 232 associated with the second message 230. When the first message 230 is matched to the “other” intent, interaction engine 124 may search the first set of outgoing edges 224 from the root node 222 for a graph unit 234, as the first message 230 does not follow a “known” path represented by nodes 222 and/or edges 224 in graph 220. When the first message 230 is matched to an outgoing edge 224 from the root node 222, interaction engine 124 attempts to matches the new intent 232 to an outgoing edge 224 from a child node 222 that represents the returned response 236 (e.g., using a machine learning model that generates predictions of class labels represented by outgoing edges 224 from that child node 222).

Interaction engine 124 may continue processing messages 230 and returning corresponding responses 236 using graph units 234 in graph 220 until the user has finished interacting with content item 218, messages 230 and/or responses 236 have been used to traverse a path from the root node 222 to a leaf node 222 in graph 220, and/or another condition is met. In some embodiments, the condition includes an action performed by the user via a corresponding message 230 and/or another type of user input.

For example, content item 218 may include a video of an instructor teaching a lesson in a course in which the user is enrolled. After playback of the video is complete, the user may generate one or more messages 230 that include questions related to the content of the lesson. Interaction engine 124 may match intents 232 associated with these questions to corresponding graph units 234 in graph 220 and use those graph units 234 to retrieve and return responses 236 to the questions (e.g., in the form of additional videos of the same instructor answering the questions). After the user has finished asking questions, the user may transmit an additional message 230 (e.g., in the form of a voice command, button click, gesture, etc.) to begin an evaluation, quiz, and/or assignment related to the content of the lesson and/or previous lessons in the course. This additional message 230 may be used to conclude interaction between the user and content item 218. Alternatively, this additional message 230 may be used to trigger additional interaction related to the evaluation, quiz, and/or assignment. During this additional interaction, which messages 230 from the user include responses to questions, tasks, and/or other instructions included in additional content outputted to the user.

In another example, content item 218 may include a trailer or “sneak peek” of an upcoming movie. After viewing content item 218, the user may transmit messages 230 that include questions related to the content, release date, and/or availability of the movie in theaters and/or on streaming platforms. Interaction engine 124 may match intents 232 associated with these questions to corresponding graph units 234 in graph 220 and use those graph units 234 to retrieve and return responses 236 to the questions (e.g., in the form of additional videos in the same style as the trailer or “sneak peek”). After the user has finished asking questions, the user may transmit an additional message 230 (e.g., in the form of a voice command, button click, gesture, etc.) to begin a process of purchasing tickets to the movie and/or enabling access to a streaming version of the movie (e.g., by renting or purchasing the movie on a streaming platform, subscribing to a streaming platform on which the movie is available, etc.).

Consequently, messages 230 and responses 236 allow the user to interact with and/or perform tasks related to content item 218 in a dynamic, guided, focused, and/or safe manner. More specifically, various paths composed of nodes 222 and edges 224 in graph 220 may be used to track messages 230 from the user and deliver corresponding responses 236 that account for previous interactions between the user and content item 218. Additionally, the generation, filtering, and use of pre-generated responses 236 to messages 230 may ensure that responses 236 are safe, relevant to content item 218, aligned with the intended use of content item 218, stylistically similar to content item 218, delivered in an efficient and/or timely manner, and/or otherwise appropriate for use with content item 218.

Further, generation engine 122 may update graph 220 based on messages 230 and/or responses 236. For example, generation engine 122 may update interaction features 216 with representations of messages 230 and/or sequences of messages 230 received from one or more users during interactions with content item 218. Generation engine 122 may use question generation model 204 and/or one or more users to generate additional questions 202 based on the updated interaction features 216. Generation engine 122 may also use classification model 206, ranking model 208, and/or filters 226 to update the set of canonical questions 238 with the additional questions 202. Generation engine 122 may additionally generate responses 236 to additional questions 202 that have been added to canonical questions 238 (e.g., using the techniques discussed above with respect to FIG. 4). Generation engine 122 may further update graph 220 with nodes 222 and edges 224 representing the new canonical questions 238 and corresponding responses 236.

After graph 220 has been updated, interaction engine 124 may use the updated graph 220 to process subsequent user interactions with content item 218. Continuing with the above example, interaction engine 124 may match one or more intents 232 associated with messages 230 received during the subsequent user interactions to graph units 234 representing the newly added canonical questions 238. Interaction engine 124 may also use these graph units 234 to retrieve and return responses 236 associated with the newly added canonical questions 238. Accordingly, generation engine 122 and interaction engine 124 may periodically and/or continually adjust the processing of user interactions with content item 218 in a way that reflects behavioral patterns, user preferences, and/or other attributes associated with previous interactions between users and content item 218.

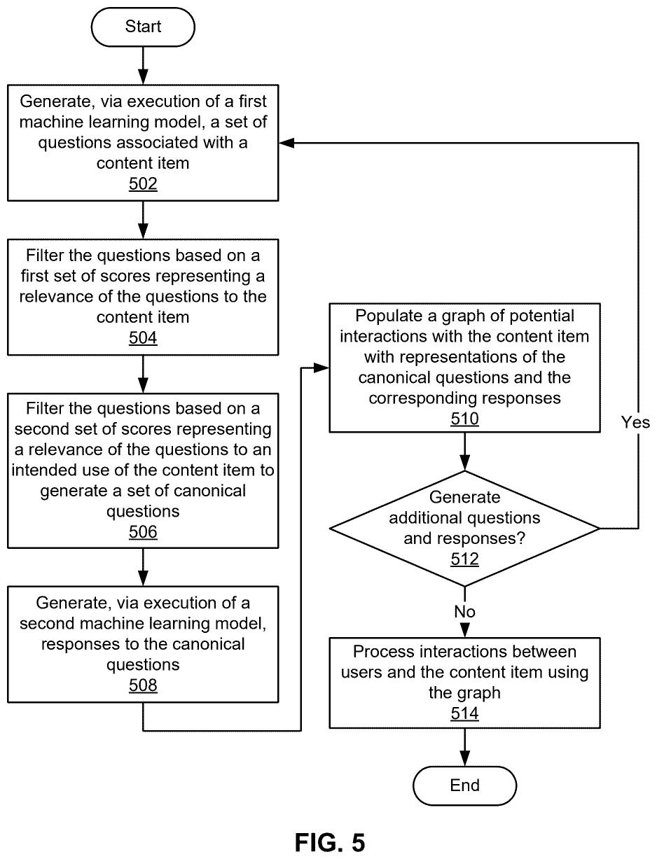

FIG. 5 is a flow diagram of method steps for generating data that can be used to conduct an interaction with a user, according to various embodiments. Although the method steps are described in conjunction with the systems of FIGS. 1-2, persons skilled in the art will understand that any system configured to perform the method steps in any order falls within the scope of the present disclosure.

As shown, in step 502, generation engine 122 generates, via execution of a first machine learning model, a set of questions associated with a content item. For example, generation engine 122 may input the content item, content item features associated with the content item, interaction features representing previous interactions with the content item and/or other content items, instructions related to generating the questions, example questions for the content item and/or other content items, and/or other information related to the content item and/or questions into an LLM, VLM, MMLM, and/or another type of machine learning model. In response to the inputted information, the machine learning model may output one or more questions that are likely to be asked by users with respect to the content item.

In step 504, generation engine 122 filters the questions based on a first set of scores representing a relevance of the questions to the content item. For example, generation engine 122 may use a first set of classifiers and/or one or more users to generate the first set of scores. Each generated score outputted by the first set of classifiers may include a numeric value that represents the likelihood that a corresponding question is relevant, safe, high quality, and/or otherwise appropriate for inclusion in an interaction between a user and the content item. Generation engine 122 may use thresholds and/or criteria related to the generated scores to filter the questions, so that questions that pass the filters meet requirements associated with relevance to the content item.

In step 506, generation engine 122 filters the questions based on a second set of scores representing a relevance of the questions to an intended use of the content item to generate a set of canonical. Continuing with the above example, generation engine 122 may use a second set of classifiers and/or one or more users to generate the second set of scores. Each generated score outputted by the second set of classifiers may include a numeric value that represents the likelihood that a corresponding question will be asked during an interaction between a user and the content item, is relevant to the intended use of the content item, and/or will improve a metric or objective to be optimized via interaction with the content item. Generation engine 122 may use thresholds and/or criteria related to the generated scores to filter the questions, so that questions that pass the filters meet requirements associated with usage of the content item. Questions that pass these filters may then be used as and/or converted into canonical questions that represent semantic intents associated with user interactions with the content item.

In step 508, generation engine 122 generates, via execution of a second machine learning model, responses to the canonical questions. For example, generation engine 122 may input each canonical question, the content item, content item features associated with the content item, interaction features representing previous interactions with the content item and/or other content items, instructions related to generating the responses, and/or other information related to the content item and/or filtered question into an LLM, VLM, MMLM, and/or another type of machine learning model. In response to the inputted information, the machine learning model may output one or more responses to the filtered question. These responses may be further filtered based on scores and/or other output generated by additional machine learning models and/or users.

In step 510, generation engine 122 populates a graph of potential interactions with the content item with representations of the filtered questions and the corresponding responses. For example, generation engine 122 may initialize the graph with a root node representing consumption of the content item by a user. Generation engine 122 may also update the graph with a set of outgoing edges from the root node, where each outgoing edge represents a different canonical question. Generation engine 122 may additionally terminate the edge in a node representing a response to the canonical question. When a given response does not depend on previously asked questions, generation engine 122 may add one or more additional edges that begin in one or more other nodes and terminate in the node representing the response. Generation engine 122 may further store, in each added node and/or edge, information that can be used to identify and/or retrieve a corresponding canonical question and/or response.

In step 512, generation engine 122 determines whether or not to generate additional questions and responses. For example, generation engine 122 may determine that additional questions and responses are to be generated until paths originating from the root node in the graph reach a certain depth, a certain number of canonical questions and corresponding responses have been generated, the canonical questions and/or responses meet goals and/or objectives related to interaction with the content item, and/or another condition is met.

While generation engine 122 determines that additional questions and responses are to be generated, generation engine 122 repeats steps 502, 504, 506, 508, and 510 to generate additional canonical questions, generate responses to the additional canonical questions, and update the graph with representations of the additional canonical questions and corresponding responses. For example, generation engine 122 may perform step 502 using updated input into the first machine learning model that includes representations of one or more canonical questions and/or corresponding responses. As a result, additional questions outputted by the first machine learning model may include follow-up questions to the canonical questions represented by outgoing edges from the root node of the graph. Generation engine 122 may perform steps 504, 506, 508, and 510 to filter the follow-up questions, generate responses to the follow-up questions, and update the graph with additional edges and nodes representing the follow-up questions and corresponding responses. Generation engine 122 may also repeat step 512 to determine whether or not additional canonical questions and responses are to be generated.

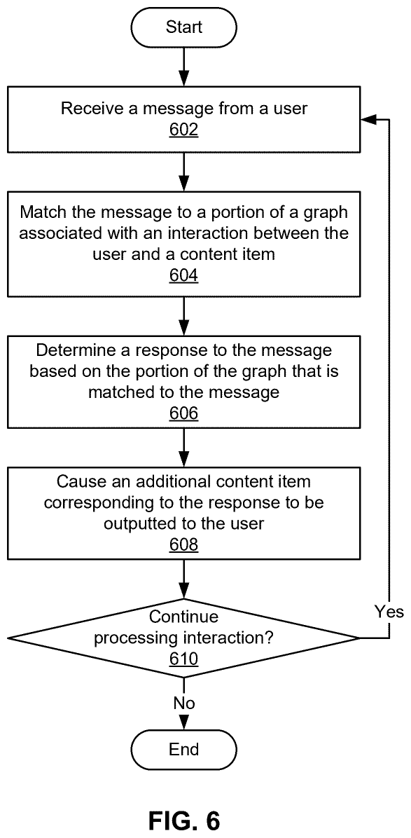

After generation engine 122 determines in step 512 that no additional questions and responses are to be generated, interaction engine 124 performs step 514, in which interaction engine 124 processes interactions between users and the content item using the graph. For example, interaction engine 124 may use the graph to determine intents associated with messages from the user and output responses to the messages, as described in further detail below with respect to FIG. 6.

FIG. 6 is a flow diagram of method steps for conducting an interaction with a user, according to various embodiments. Although the method steps are described in conjunction with the systems of FIGS. 1-2, persons skilled in the art will understand that any system configured to perform the method steps in any order falls within the scope of the present disclosure.

As shown, in step 602, interaction engine 124 receives a message from a user. For example, interaction engine 124 may receive the message before, during, and/or after consumption of a content item by the user. The message may be provided as speech, text, one or more gestures, and/or other types of input from the user.

In step 604, interaction engine 124 matches the message to a portion of a graph associated with an interaction between the user and the content item. For example, the graph may be generated by generation engine 122 as a representation of potential interactions between users and the content item, as discussed above. Interaction engine 124 may convert the message into text, an embedding, and/or another semantic representation of an intent of the user. Interaction engine 124 may also search one or more levels of the graph for an edge and/or another portion of the graph that is semantically closest to the intent.

In step 606, interaction engine 124 determines a response to the message based on the portion of the graph that is matched to the message. Continuing with the above example, interaction engine 124 may use an edge in the graph that is matched to the message to retrieve a node into which the edge terminates. This node may represent a pre-generated response to the message. Alternatively, if the message does not match any portions of the graph, interaction engine 124 may determine that a “default” response is to be used.

In step 608, interaction engine 124 causes an additional content item corresponding to the response to be outputted to the user. Continuing with the above example, interaction engine 124 may use information stored in and/or associated with the node to retrieve the content item. Interaction engine 124 may also transmit the content item to a computing device of the user, so that the content item can be outputted via an interface provided by the computing device and/or one or more output devices associated with the computing device.

In step 610, interaction engine 124 determines whether or not to continue processing the interaction with the user. For example, interaction engine 124 may determine that the interaction should continue to be processed while messages are received from the user, the user has not provided input representing an end of the interaction, and/or another condition is met.

While interaction engine 124 determines that processing of the interaction is to continue, interaction engine 124 repeats steps 602, 604, 606, and 608 to match additional messages from the user to corresponding portions of the graph and generate responses to the additional messages using the matching portions of the graph. Interaction engine 124 also repeats step 610 to determine whether or not to continue with the interaction. After a condition representing the end of the interaction is met (e.g., the user has signaled that the interaction is complete, messages and/or responses have been used to traverse a path from the root node to a leaf node in the graph, the user has performed an action that triggers the end of the interaction, etc.), interaction engine 124 discontinues processing the interaction.

In sum, the disclosed techniques perform data-driven interaction between a user and a content item. During this data-driven interaction, content associated with the content item is selected, modified, and/or outputted based on questions and/or other types of interactive input from the user. For example, the content item may include a movie, television show, informational video, instructional video, and/or another type of video that is outputted to the user. After the user has viewed some or all of the video, the user may ask questions, provide comments, and/or generate other types of user input related to characters, locations, objects, topics, concepts, data points, guidelines, suggestions, and/or other attributes associated with content presented in the video. Each user input is matched to a corresponding response, and the response is outputted to the user as text, another video, and/or another type of content.

The data-driven interaction may be performed using a graph representing potential interactions between users and the content item. The graph may include a root node that represents consumption of the content item by a user and one or more additional nodes that represent consumption of additional content related to the content item by the user. The graph may also include directed edges between pairs of nodes, where each directed edge represents a question and/or another type of input from the user after the user has consumed content represented by a node from which the directed edge originates. Another node into which the directed edge terminates represents a response to the input represented by the directed edge. This other node may be used to retrieve the response as a pre-generated video and/or another type of content item.

During a given interaction between the user and the content item, each message received from the user is converted into an intent, and the intent is matched to a corresponding portion of the graph. The matching portion of the graph is used to retrieve a response to the intent, and the response is returned and/or outputted to the user. A subsequent message from the user is then matched to a different portion of the graph that descends from previously matched portions of the graph. Thus, processing of messages from the user and generation of response to the messages during a given interaction may be guided by and/or performed using a corresponding path within the graph.

One technical advantage of the disclosed techniques relative to the prior art is an increase in the range of interactions that can be conducted between users and content items. More specifically, various paths composed of nodes and edges in the graph may be used to track messages from the user and deliver corresponding responses that account for previous interactions between the user and the content item. Consequently, interactions that are conducted using the disclosed techniques may be more dynamic, nuanced, and engaging than conventional approaches that are limited in the ability to receive and/or process user inputs related to content items. Another technical advantage of the disclosed techniques is the ability to generate and deliver responses to messages from the user that are safe, relevant to the content item, aligned with the intended use of the content item, stylistically similar to the content item, delivered in an efficient and/or timely manner, and/or otherwise appropriate for use in an interaction with the content item. These technical advantages provide one or more technological improvements over prior art approaches.
1. In some embodiments, a computer-implemented method for processing user input comprises determining, via execution of a first machine learning model, a first intent associated with a first message that is received from a user during an interaction associated with a first content item; matching the first intent to a first portion of a graph associated with the interaction; determining, based on the first portion of the graph, a first response to the first message; and causing a second content item corresponding to the first response to be outputted to the user.
2. The computer-implemented method of clause 1, further comprising determining a second intent associated with a second message that is received from the user after the first response is outputted; matching the second intent to a second portion of the graph, wherein the first portion of the graph and the second portion of the graph lie on a common path; and causing a second response to the second message to be outputted based on the second portion of the graph.
3. The computer-implemented method of any of clauses 1-2, further comprising generating, via execution of a second machine learning model, the second content item based on one or more attributes of the first content item.
4. The computer-implemented method of any of clauses 1-3, wherein the one or more attributes of the first content item comprise at least one of a background, a character, a face, a key scene, or a voice.
5. The computer-implemented method of any of clauses 1-4, further comprising generating, via execution of a second machine learning model, a plurality of questions associated with the first content item; and generating the graph based on the plurality of questions.
6. The computer-implemented method of any of clauses 1-5, wherein generating the plurality of questions comprises inputting a first question included in the plurality of questions into the second machine learning model; and generating, via execution of the second machine learning model based on the first question, one or more additional questions that are (i) included in the plurality of questions and (ii) correspond to one or more follow-up questions associated with the first question.
7. The computer-implemented method of any of clauses 1-6, wherein generating the graph comprises adding a first edge representing the first question to the graph; connecting the first edge to a first node representing a response to the first question; and adding, to the graph, one or more edges representing the one or more additional questions as one or more outgoing edges from the first node.
8. The computer-implemented method of any of clauses 1-7, wherein generating the graph comprises generating a plurality of scores associated with the plurality of questions; filtering the plurality of questions based on the plurality of scores; and populating the graph with representations of a plurality of canonical questions corresponding to the filtered plurality of questions.
9. The computer-implemented method of any of clauses 1-8, wherein the plurality of questions is generated based on at least one of metadata associated with the first content item, the content item, historical user interactions associated with the first content item, or historical user interactions associated with one or more additional content items.
10. The computer-implemented method of any of clauses 1-9, wherein the first content item comprises a first video and the first response comprises a second video.
11. In some embodiments, one or more non-transitory computer-readable media store instructions that, when executed by one or more processors, cause the one or more processors to perform the steps of determining, via execution of a first machine learning model, a first intent associated with a first message that is received from a user during an interaction associated with a first content item; matching the first intent to a first portion of a graph associated with the interaction; determining, based on the first portion of the graph, a first response to the first message; and causing a second content item corresponding to the first response to be outputted to the user.
12. The one or more non-transitory computer-readable media of clause 11, wherein the instructions further cause the one or more processors to perform the steps of determining a second intent associated with a second message that is received from the user after the first response is outputted; matching the second intent to a second portion of the graph, wherein the first portion of the graph and the second portion of the graph lie on a common path; and causing a second response to the second message to be outputted based on the second portion of the graph.
13. The one or more non-transitory computer-readable media of any of clauses 11-12, wherein matching the first intent to the first portion of the graph comprises searching a first level of the graph for the first portion, and matching the second intent to the second portion of the graph comprises searching a second level of the graph for the second portion.
14. The one or more non-transitory computer-readable media of any of clauses 11-13, wherein the second level of the graph is lower than the first level of the graph.
15. The one or more non-transitory computer-readable media of any of clauses 11-14, wherein the instructions further cause the one or more processors to perform the steps of inputting a canonical question corresponding to the first intent and one or more attributes associated with the first content item into a second machine learning model; generating, via execution of the second machine learning model, the second content item having the one or more attributes of the first content item; and storing a representation of the second content item in association with the first portion of the graph.
16. The one or more non-transitory computer-readable media of any of clauses 11-15, wherein the instructions further cause the one or more processors to perform the steps of generating, via execution of a second machine learning model, a plurality of questions associated with the first content item; filtering the plurality of questions based on a plurality of scores associated with the plurality of questions to generate a plurality of canonical questions; and generating the graph based on the plurality of canonical questions.
17. The one or more non-transitory computer-readable media of any of clauses 11-16, wherein the plurality of scores comprises a first score representing a relevance of a question included in the plurality of questions to the first content item and a second score representing a relevance of the question to an intended use associated with the first content item.
18. The one or more non-transitory computer-readable media of any of clauses 11-17, wherein generating the plurality of questions comprises generating, via execution of the second machine learning model, a first question included in the plurality of questions; and generating, via execution of the second machine learning model based on the first question, one or more additional questions that are (i) included in the plurality of questions and (ii) correspond to one or more follow-up questions associated with the first question.
19. The one or more non-transitory computer-readable media of any of clauses 11-18, wherein the first portion of the graph comprises (i) an edge representing the first intent and (ii) a node that is connected to the edge and represents the first response.
20. In some embodiments, a system comprises one or more memories that store instructions, and one or more processors that are coupled to the one or more memories and, when executing the instructions, are configured to perform the steps of determining, via execution of a first machine learning model, a plurality of questions associated with a content item; generating, via execution of a second machine learning model, a plurality of responses to the plurality of questions; generating a graph that includes a plurality of edges representing the plurality of questions and a plurality of nodes representing the plurality of responses; and processing an interaction between a user and the content item based on the graph.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for processing user input, the method comprising:
determining, via execution of a first machine learning model, a first intent associated with a first message that is received from a user during an interaction associated with a first content item;
matching the first intent to a first portion of a graph associated with the interaction;
determining, based on the first portion of the graph, a first response to the first message; and
causing a second content item corresponding to the first response to be outputted to the user.

2. The computer-implemented method of claim 1, further comprising:
determining a second intent associated with a second message that is received from the user after the first response is outputted;
matching the second intent to a second portion of the graph, wherein the first portion of the graph and the second portion of the graph lie on a common path; and
causing a second response to the second message to be outputted based on the second portion of the graph.

3. The computer-implemented method of claim 1, further comprising generating, via execution of a second machine learning model, the second content item based on one or more attributes of the first content item.

4. The computer-implemented method of claim 3, wherein the one or more attributes of the first content item comprise at least one of a background, a character, a face, a key scene, or a voice.

5. The computer-implemented method of claim 1, further comprising:
generating, via execution of a second machine learning model, a plurality of questions associated with the first content item; and
generating the graph based on the plurality of questions.

6. The computer-implemented method of claim 5, wherein generating the plurality of questions comprises:
inputting a first question included in the plurality of questions into the second machine learning model; and
generating, via execution of the second machine learning model based on the first question, one or more additional questions that are (i) included in the plurality of questions and (ii) correspond to one or more follow-up questions associated with the first question.

7. The computer-implemented method of claim 6, wherein generating the graph comprises:
adding a first edge representing the first question to the graph;
connecting the first edge to a first node representing a response to the first question; and
adding, to the graph, one or more edges representing the one or more additional questions as one or more outgoing edges from the first node.

8. The computer-implemented method of claim 5, wherein generating the graph comprises:
generating a plurality of scores associated with the plurality of questions;
filtering the plurality of questions based on the plurality of scores; and
populating the graph with representations of a plurality of canonical questions corresponding to the filtered plurality of questions.

9. The computer-implemented method of claim 5, wherein the plurality of questions is generated based on at least one of metadata associated with the first content item, historical user interactions associated with the first content item, or historical user interactions associated with one or more additional content items.

10. The computer-implemented method of claim 1, wherein the first content item comprises a first video and the first response comprises a second video.

11. One or more non-transitory computer-readable media storing instructions that, when executed by one or more processors, cause the one or more processors to perform the steps of:
determining, via execution of a first machine learning model, a first intent associated with a first message that is received from a user during an interaction associated with a first content item;
matching the first intent to a first portion of a graph associated with the interaction;
determining, based on the first portion of the graph, a first response to the first message; and
causing a second content item corresponding to the first response to be outputted to the user.

12. The one or more non-transitory computer-readable media of claim 11, wherein the instructions further cause the one or more processors to perform the steps of:
determining a second intent associated with a second message that is received from the user after the first response is outputted;
matching the second intent to a second portion of the graph, wherein the first portion of the graph and the second portion of the graph lie on a common path; and
causing a second response to the second message to be outputted based on the second portion of the graph.

13. The one or more non-transitory computer-readable media of claim 12, wherein:
matching the first intent to the first portion of the graph comprises searching a first level of the graph for the first portion, and
matching the second intent to the second portion of the graph comprises searching a second level of the graph for the second portion.

14. The one or more non-transitory computer-readable media of claim 13, wherein the second level of the graph is lower than the first level of the graph.

15. The one or more non-transitory computer-readable media of claim 11, wherein the instructions further cause the one or more processors to perform the steps of:
inputting a canonical question corresponding to the first intent and one or more attributes associated with the first content item into a second machine learning model;
generating, via execution of the second machine learning model, the second content item having the one or more attributes of the first content item; and
storing a representation of the second content item in association with the first portion of the graph.

16. The one or more non-transitory computer-readable media of claim 11, wherein the instructions further cause the one or more processors to perform the steps of:
generating, via execution of a second machine learning model, a plurality of questions associated with the first content item;
filtering the plurality of questions based on a plurality of scores associated with the plurality of questions to generate a plurality of canonical questions; and
generating the graph based on the plurality of canonical questions.

17. The one or more non-transitory computer-readable media of claim 16, wherein the plurality of scores comprises a first score representing a relevance of a question included in the plurality of questions to the first content item and a second score representing a relevance of the question to an intended use associated with the first content item.

18. The one or more non-transitory computer-readable media of claim 16, wherein generating the plurality of questions comprises:
generating, via execution of the second machine learning model, a first question included in the plurality of questions; and
generating, via execution of the second machine learning model based on the first question, one or more additional questions that are (i) included in the plurality of questions and (ii) correspond to one or more follow-up questions associated with the first question.

19. The one or more non-transitory computer-readable media of claim 11, wherein the first portion of the graph comprises (i) an edge representing the first intent and (ii) a node that is connected to the edge and represents the first response.

20. A system, comprising:
one or more memories that store instructions, and
one or more processors that are coupled to the one or more memories and, when executing the instructions, are configured to perform the steps of:
determining, via execution of a first machine learning model, a plurality of questions associated with a content item;
generating, via execution of a second machine learning model, a plurality of responses to the plurality of questions;
generating a graph that includes a plurality of edges representing the plurality of questions and a plurality of nodes representing the plurality of responses; and
processing an interaction between a user and the content item based on the graph.
